(19) United States
(12) Patent Application Publication
(10) Pub. No.: US 2009/0234744 A1
(43) Pub. Date: Sep. 17, 2009

(54) SOFTWARE AND METHOD FOR PRODUCING ART AND ART OBJECTS, INCLUDING MULTIMEDIA OVER A CENTRALLY MANAGED COMMUNICATIONS NETWORK CONNECTING ART IDEA CREATORS AND ART IDEA IMPLEMENTERS/PRODUCERS IN A FORUM

(76) Inventor: Vagish Kapila, San Jose, CA (US)

Correspondence Address: J.G. MULLINS, P.O. Box 641391, San Jose, CA, 95164, US

(21) Appl. No.: 12/472,289

(22) Filed: May 26, 2009

Related U.S. Application Data
(63) Continuation-in-part of application No. 12/026,656, filed on Feb. 6, 2008.

(51) Int. Cl. G06Q 30/00; G06F 15/16; G06F 21/20

(52) U.S. Cl. 705/14; 726/15

(57) ABSTRACT

The present invention provides a computer system running software with software implemented methods providing a secure private or virtual private communications network access for network users identified by the network as having permission for network access as either a member or guest and providing an enhanced way computer assisted production of art and art objects over the centrally managed network utilizing computer implemented methods for art idea creator network members to communicate with art idea implementers/producers in a forum to produce and sell art or art objects, wherein art idea creator end users and art idea implementer/producer end users receive one or more of prizes, a portion of sale proceeds for any art produced as a direct result of their contributions to the forum, or a portion of advertising proceeds for advertising that targets forum visitors, or viewers of posted art. In another aspect the invention provides an improved method for computer assisted production of art and art objects comprising a contest forum to evaluate the work of artists in a public forum to provide valuable feedback for artists to use to improve their art skills and the art's appeal to others. The art may include, but is not limited to, two dimensional art, three dimensional art, body art, or multimedia art. Payment by the network managers to art idea creators and art end users may be shared revenue, free or reduced service costs, gifts or awards, or some combination thereof.

### TECHNICAL FIELD

The present invention relates generally to a computer system running software with software implemented methods providing a secure private or virtual private communications network access for network users identified by the network as having permission for network access as either a member or guest and providing an enhanced way computer assisted production of art and art objects, including multimedia music and video as a creation or co-creation over the centrally managed network utilizing computer implemented methods for art idea creator network members to communicate with art idea implementers/producers in a forum to produce and sell art or art objects, wherein art idea creator end users and art idea implementer/producer end users receive one or more of prizes, a portion of sale proceeds for any art produced as a direct result of their contributions to the forum, or a portion of advertising proceeds for advertising that targets forum visitors, or viewers of posted art. In another aspect the invention relates to an improved method for computer assisted production of art and art objects comprising a contest forum to evaluate the work of artists in a public forum to provide valuable feedback for artists to use to improve their art skills and the art's appeal to others. The payment by the network managers to art idea creators and art end users may be shared revenue, free or reduced service costs, gifts or awards, or some combination thereof.

### BACKGROUND

The arts are a matter of personal taste and artists often have a difficult time determining whether their art has any appeal to others that may be translated into personal income or revenue. Historically, artists often reach their greatest popularity and their works have the greatest value after they are deceased, or have been practicing art for many years without ever being recognized for the quality and value of their work.

Vocal artists and musicians sometimes take advantage of talent shows and television series, such as American Idol in an attempt to check their work against a voting audience to see if their artistic talent will have wide appeal. While such a forum can identify whether someone has one kind of talent, such as vocal skill and training, it does not test their ability to choose or create original art that will have wide appeal. Even the winners of such widely viewed and voted upon in shows such as American Idol do not necessarily meet with much success after being a winner, only better options for success. Part of the problem may be that network time is limited and expensive, so there is a limited range of time and opportunities for a vocalist to showcase their talents. In addition, they are often performing the “hits’ of others and this does not predict whether there is any likelihood of producing or selecting original music as material sufficient to have an audience appeal.

Art, such as two dimensional and three dimensional arts, e.g., photography, painting, sculpting, art object creations or art modifications of objects, or tattoo design or implementations, and the like, is even more difficult as a talent for an audience to find an audience to help fine tune their art to refine it for a wide audience appeal. There are few forum locations that are not expensive, exclusive or have limited audience that such artists may utilize for their craft. Magazines are often too restrictive, too niche or too limited in their audience to be of much assistance. Making a set of web pages on MySpace, FaceBook, or the like, on creating a commercial website to display or sell one's art does not guarantee enough traffic, or the right kind to traffic, to showcase one's art or to gauge how others might feel about it. In addition, there is very little opportunity for feedback or sharing creative ideas with other artists (particularly well-know or very good artists) that might assist an unknown, little know, or learning artist in refining their art to provide a wide appeal, to get real feedback, or to compare their work to the work of other artists, and have a social forum to discuss their work or ideas with other artists or those who like to view or buy art.

In addition, vocal artists, musicians, video artists, flash, websites, and similar types of multimedia artists do not have a reasonable creation or co-creation forum where they can offer original ideas that have created or that they want to create to a forum for feedback, or as an offer to seek help from a co-creation artist who can turn the ideas into multimedia reality. In addition creative artists seeking co-creation contracts need a fertile forum where they can find persons with ideas that can utilized their co-creative ability to produce multimedia.

Accordingly, there is a need for a secure private or virtual private communications artistic network with access for network users identified by the network as having permission for network access as either a member or guest with a forum and software implemented methods to provide an enhanced way for computer assisted production of art and art objects over the centrally managed network utilizing computer implemented methods for art idea creator network members to communicate with art idea implementers/producers in a forum to produce and sell art or art objects, wherein art idea creator end users and art idea implementer/producer end users receive one or more of prizes, a portion of sale proceeds for any art produced as a direct result of their contributions to the forum, or a portion of advertising proceeds for advertising that targets forum visitors, or viewers of posted art.

In addition there is a need for improved computer assisted production of art and art objects comprising a contest forum to evaluate the work of artists in the network forum, providing valuable feedback for artists who submit art to the forum to use to improve their art skills and the appeal of their art to others by posting their work in a forum for evaluation by others network members during a periodic art popularity and appeal contest, wherein their art may be compared to the work of other artists in a general artistic sense or compared in regard to their implementation of a contest idea in art form after an art concept idea is submitted to the forum for an art design contest, and further comprising opportunities for artists to improve their art skills and appeal of their work to others by resubmitting their art based on improved knowledge of its appeal to others for evaluation by other network users in order to improve their production of art and art objects.

### SUMMARY OF THE INVENTION

An object of the present invention is to provide a computer system running software with software implemented methods providing a secure private or virtual private communications network access for network users identified by the network as having permission for network access as either a member or guest and providing an enhanced way computer assisted production of art and art objects over the centrally managed network utilizing computer implemented methods for art idea creator network members to communicate with art idea implementers/producers in a forum to produce and sell art or art objects, wherein art idea creator end users and art idea implementer/producer end users receive one or more of prizes, a portion of sale proceeds for any art produced as a direct result of their contributions to the forum, or a portion of advertising proceeds for advertising that targets forum visitors, or viewers of posted art.

A further object of the present invention is to provide such a system including a co-creation forum where persons can offer up ideas for co-creation and artists can offer up co-creative services to persons seeking such services.

A still further object of the present invention is to provide such a system including a forum for vocal artists, musicians, video artists, flash artists, websites creators, and similar types of multimedia artists as a creation or co-creation forum where persons can offer up original ideas that have been created or that need co-creation efforts to finalize creation to a forum for feedback, or as an offer to seek help from a co-creation artist who can turn the ideas into multimedia reality. A preferred system gives creative artists seeking co-creation contracts a fertile forum for creative ideas where they can find persons with ideas where the artist can provide co-creative ability to produce multimedia.

Another object of the present invention is to provide a computer system running software with software implemented methods providing a secure private or virtual private communications network access for network users identified by the network as having permission for network access as either a member or guest and providing software implemented methods for improved computer assisted production of art and art objects comprising a contest forum to evaluate the work of artists in the network forum, while providing valuable feedback for artists who submit art to the forum to use to improve their art skills and the appeal of their art to others by posting their work in a forum for evaluation by others network members during a periodic art popularity and appeal contest, wherein their art may be compared to the work of other artists in a general artistic sense or compared in regard to their implementation of a contest idea in art form after an art concept idea is submitted to the forum for an art design contest, and further comprising opportunities for artists to improve their art skills and appeal of their work to others by resubmitting their art based on improved knowledge of its appeal to others for evaluation by other network users in order to improve their creation and production of art and art objects.

Another object of the present invention is to provide a computer system running software with software implemented methods providing a secure private or virtual private communications network access for network users identified by the network as having permission for network access as either a member or guest and further providing software implemented methods for network managers to track and pay art idea creators and art end users who participate in the forum as described above, wherein such payment may be shared revenue, free or reduced service costs, gifts or awards, or some combination thereof.

One object of the invention is to provide software implemented methods to identify a network end user in their role as an art idea creator, an art idea implementer/provider, or both, and to provide software implemented methods to establish an end user network member payment account and tracking software for sharing network revenue generated within the network as a result of one or more of (i) access, participation, and contributions by the network end user, (ii) assess, participation, and winning a prize for accurately choosing and best predicting best art contest winners on the forum, (iii) access and providing an art idea or concept that is an art contest winner within the forum, and (iv) access and providing an art implementation or art object that is an art contest winner within the forum.

In a preferred object, the invention provides such a private or virtual private network that includes an artist social network of private commercial or non-commercial web pages of information and posted art, wherein individual private web page owners can post information, profiles or art for sale, and the forum can optionally agree to pay web page owners a percentage of any revenue from advertising resulting from network use of a frame, or area, of their web page or web pages when the frame or frames is/are used by the network for promoting and offering advertiser's products or services to targeted network users or group of users that visit the private web page, or pages. In a preferred object of the invention, the secure private or virtual private network provides and promotes a method for private artist web page owners in a social artists' network to capitalize the popularity and appeal value of their private web page, or web pages, and their art, which are located on a social network of private artist web pages.

In a preferred object, the invention provides art auctions or art objects for sale in an eStore forum and the forum may share a percentage of the revenue from such auctions or sales with art idea creators, art idea implementers/producers, or both for any sales of art resulting directly from contributions to the production of saleable art or art objects by art idea creators, art idea implementers/producers, or both.

In another preferred object, the invention provides such a private or virtual private creative artist network forum that includes end users that have a network of contacts that are friends or online acquaintance, wherein the inviting end user can receive revenue, awards or prizes for the number of end user that they invite to the forum and who become forum network member end users, and provides end users a way to profit from the network access of the forum and forum participation from their social network of contacts and capitalize on the popularity and appeal value of their private contacts.

A preferred object of the invention is to provide such a network, including a network of artist social website pages and artist creative art production forum, comprising:
(i) computer software including software logic and at least one interface for a network user to be identified by the network as a known prior user, or to provide to the network through the interface enough identifying information to qualify as a newly identified network user, with sufficient permission to access the private or virtual private network,
(ii) computer software including software logic sufficient to verify a network user's identify, and track the network connection of the network user as the network user accesses the private network or virtual private network system, for example by the use of unique network log on identifiers, by a personal registered toolbar, or a combination thereof, and
(iii) computer software implementing a method for (a) accurately identifying and connecting specific network users who wish to access private web pages located within a social network of web pages that are offered on the network, (b) identifying commercial and non-commercial artist web page owners within the artist social network and creative art forum with advertising on their web pages, or associated with their web pages to track their share of advertising revenue generated by visitors to their web pages, (c) identifying product or services advertisers who wish to target said network users with advertisements in exchange for payment of advertising revenue to the network when end users access a particular social network of artist web pages, (d) providing an interface for such product or services advertisers to select network web pages with end users visitors that advertisers wish to target and to obtain the right to target such specific network users for a set fee, and (d) optionally providing shared revenue to commercial and non-commercial artist web page owners within the private network generated by the targeted end users of such web pages.

Another preferred object of the invention is to provide such an artist forum and creative art production network, including a network of end users and their end user contact listing groups, comprising:
(i) computer software including software logic and at least one interface for a network user to be identified by the network as a known prior user, or to provide to the network through the interface enough identifying information to qualify as a newly identified network user, with sufficient permission to access the private or virtual private network,
(ii) computer software including software logic sufficient to verify a network user's identify, and track the network connection of the network user as the network user accesses the private network or virtual private network system, for example by the use of unique network log on identifiers, by a personal registered toolbar, or a combination thereof, and
(iii) computer software implementing a method for (a) accurately identifying and connecting specific network users who are an end user and their invited contacts who wish to access the private or virtual private network after having been referred by the end user, (b) identifying end users who have contact listing referrals as being associated with their referred end users who elect to participate in the creative art production network artistic network forum, (c) identifying product or services advertisers who wish to target said network users with advertisements in exchange payment of advertising revenue to the network when end users access particular artist forum and creative art production network web pages, (d) providing an interface for such product or services advertisers to select artist forum and creative art production network web pages, or sets of web pages and to obtain the right to target such specific network users for a set fee, and (e) providing shared revenue to artist forum and creative art production network web page owners for advertising on their web pages or to visitors of their web pages.

In a preferred object, the web pages located within the social network are equipped with imbedded information regarding where advertisements can be inserted, or when advertisements can be played . . . such as before the web page is played or simultaneously with the media in a window, banner or background. Tracking software tailors the advertisement to the individual web pages and tracks revenue generated by the web page visitors to whom advertisements are presented.

Additional objects, advantages and novel features of the invention will be set forth in part in the description which follows, and in part will become apparent to those skilled in the art upon examination of the following, or may be learned by practice of the invention.

### DETAILED DESCRIPTION OF THE INVENTION

### Definitions and Nomenclature

The term “access key or keys” in the context of the artist forum and creative art production social network of web pages refers to the use of one or more identifier keys or passwords that define or limit access to certain web pages on the artist forum and creative art production network social network.

The term “art” in the context of the artist forum and creative art production social network refers to two dimensional or three-dimensional drawings, sculptures, castings, or other images that may be displayed, scratched, scrawled, painted, marked, imbedded, etched, extruded or shaped in any manner by tools, machines, computers, human hands or other instruments.

The terms “artist forum and creative art production network” or “TapSmack” are alternative terms that refer to a registered user network of collective artistic forum and creative art production web pages for individuals that have a common interest in creating art, creating ideas for art, or for viewing the creative art works of others, and may refer to private individuals with this common social factor as a common interest such as communicating with friends or new people that are also interested in art, and may refer to a group of individuals or to an organization as well as to a physical person.

The term “idea” as used herein with respect to original art creation may refer to formed art concept, a written or drawn description of an art concept, an imagination of a form or art concept, or the like, and may be complete or incomplete in its form. Further, it may be an imaginative or real composite of multiple concepts from a number of individuals or sources, for art or the like.

The term “co-creation” as used herein with respect to original art creation means two or more persons share an idea or concept and collaborate to produce art in a tangible medium.

The term “metadata” in an object data programming language context refers to information about the content of programming objects or data objects. One may think of it in lay terms as a description summary or index for describing present content or possible future content for an object programming language object. For example, chunks or pieces of digital data (whether encrypted or decrypted) may exist in an object or in a group of objects that are linked together in an object schema (structure or order).

Other object programming language terms and internet terms are to be given their ordinary and expected meaning within the context of this application. A meaning for such terms can be readily obtained by reviewing descriptive literature that is available from the author and provider of such object programming languages.

The term “private or virtual private network” refers to a network that is connected over a local or distributed discrete network of connections, or is loosely connected of a distributed virtual network by permitted connections only when communications are needed, and wherein accessing the network requires registration that creates a limited access to private network members according to network rules, and may refer to or include individuals, groups, or organizations, using computers, telephones, PDA, or other communication devices capable of communicating with or accessing the network.

### DETAILED DESCRIPTION OF THE INVENTION

An embodiment of the invention provides a computer system running software with software implemented methods providing a secure private or virtual private communications network access for network users identified by the network as having permission for network access as either a member or guest and providing an enhanced way computer assisted production of art and art objects over the centrally managed network utilizing computer implemented methods for art idea creator network members to communicate with art idea implementers/producers in a forum to produce and sell art or art objects, wherein art idea creator end users and art idea implementer/producer end users receive one or more of prizes, a portion of sale proceeds for any art produced as a direct result of their contributions to the forum, or a portion of advertising proceeds for advertising that targets forum visitors, or viewers of posted art.

As an example of this embodiment, a private or virtual private creative artist network forum that may be called by the aesthetic term “TapSmack” provides a forum for sports fans with artistic idea to post a request for stickers, temporary tattoos, permanent tattoos, art objects, art modified clothing and the like and artists may offer their ideas in a closed artist only contest for the idea creator or others to evaluate, or in a public contests for registered users of the forum to evaluate, wherein the winner of an art implementation or art production of the submitted idea may be rewarded by a purchase of their idea, or a percentage of sales of art or objects that implement the idea, and the person that submitted the artistic idea to be implemented may also be rewarded with a portion of revenue from sales of art or objects. Periodic contests for the best art idea submission, the best art idea implementation or both, may result in prizes to the winners, and optionally to network member views that vote on the art and best predict the winner of a contest, before the close of a contest. Artist and other network member users may post profiles and may choose to communicate with other forum members via the forum network communication systems.

Another embodiment of the present invention provides a computer system running software with software implemented methods providing a secure private or virtual private communications network access for network users identified by the network as having permission for network access as either a member or guest and providing software implemented methods for improved computer assisted production of art and art objects comprising a contest forum to evaluate the work of artists in the network forum, while also providing valuable feedback for artists who submit art to the forum to use to improve their art skills and the appeal of their art to others by posting their work in a forum for evaluation by others network members during a periodic art popularity and appeal contest, wherein their art may be compared to the work of other artists in a general artistic sense or compared in regard to their implementation of a contest idea in art form after an art concept idea is submitted to the forum for an art design contest, and further comprising opportunities for artists to improve their art skills and appeal of their work to others by resubmitting their art based on improved knowledge of its appeal to others for evaluation by other network users in order to improve their production of art and art objects.

A further embodiment of the present invention provides such a system including a co-creation forum where persons can offer up ideas for co-creation and artists can offer up co-creative services to persons seeking such services.

A still further embodiment of the present invention is provides such a system including a forum for vocal artists, musicians, video artists, flash artists, websites creators, and similar types of multimedia artists as a creation or co-creation forum where persons can offer up original ideas that have been created or that need co-creation efforts to finalize creation to a forum for feedback, or as an offer to seek help from a co-creation artist who can turn the ideas into multimedia reality.

A more preferred system embodiment provides a forum for creative artists seeking co-creation contracts with a fertile forum for creative ideas where they can find persons with ideas and the artist can provide co-creative ability as a service to produce multimedia.

Still another embodiment of the present invention provides a computer system running software with software implemented methods for providing a secure private or virtual private communications network access for network users identified by the network as having permission for network access as either a member or guest and further providing software implemented methods for network managers to track and pay art idea creators and art end users who participate in the forum as described above, wherein such payment may be shared revenue, free or reduced service costs, gifts or awards, or some combination thereof.

Yet another embodiment of the invention provides software implemented methods to identify a network end user in their role as an art idea creator, an art idea implementer/provider, or both, and to provide software implemented methods to establish an end user network member payment account and tracking software for sharing network revenue generated within the network as a result of one or more of (i) access, participation, and contributions by the network end user, (ii) assess, participation, and winning a prize for accurately choosing and best predicting best art contest winners on the forum, (iii) access and providing an art idea or concept that is an art contest winner within the forum and (iv) access and providing an art implementation or art object that is an art contest winner within the forum.

In a preferred embodiment, the invention provides such a private or virtual private network that includes an artist social network of private commercial or non-commercial web pages of information and posted art, wherein individual private web page owners can post information, profiles or art for sale, and the forum can optionally agree to pay web page owners a percentage of any revenue from advertising resulting from network use of a frame, or area, of their web page or web pages when the frame or frames is/are used by the network for promoting and offering advertiser's products or services to targeted network users or group of users that visit the private web page, or pages. In a preferred object of the invention, the secure private or virtual private network provides and promotes a method for private artist web page owners in a social artists' network to capitalize the popularity and appeal value of their private web page, or web pages, and their art, which are located on a social network of private artist web pages.

In another preferred embodiment, the invention provides art auctions or art objects for sale in an eStore forum and the forum may share a percentage of the revenue from such auctions or sales with art idea creators, art idea implementers/producers, or both for any sales of art resulting directly from contributions to the production of saleable art or art objects by art idea creators, art idea implementers/producers, or both.

In still another preferred object, the invention provides such a private or virtual private creative artist network forum that includes end users that have a network of contacts that are friends or online acquaintance, wherein the inviting end user can receive revenue, awards or prizes for the number of end user that they invite to the forum and who become forum network member end users, and provides end users a way to profit from the network access of the forum and forum participation from their social network of contacts and capitalize on the popularity and appeal value of their private contacts.

Another preferred embodiment of the invention is to provide such a network, including a network of artist social website pages and artist creative art production forum, comprising:
(i) computer software including software logic and at least one interface for a network user to be identified by the network as a known prior user, or to provide to the network through the interface enough identifying information to qualify as a newly identified network user, with sufficient permission to access the private or virtual private network,
(ii) computer software including software logic sufficient to verify a network user's identify, and track the network connection of the network user as the network user accesses the private network or virtual private network system, for example by the use of unique network log on identifiers, by a personal registered toolbar, or a combination thereof, and
(iii) computer software implementing a method for (a) accurately identifying and connecting specific network users who wish to access private web pages located within a social network of web pages that are offered on the network, (b) identifying commercial and non-commercial artist web page owners within the artist social network and creative art forum with advertising on their web pages, or associated with their web pages to track their share of advertising revenue generated by visitors to their web pages, (c) identifying product or services advertisers who wish to target said network users with advertisements in exchange for payment of advertising revenue to the network when end users access a particular social network of artist web pages, (d) providing an interface for such product or services advertisers to select network web pages with end users visitors that advertisers wish to target and to obtain the right to target such specific network users for a set fee, and (d) optionally providing shared revenue to commercial and non-commercial artist web page owners within the private network generated by the targeted end users of such web pages.

Still another preferred embodiment of the invention provides such an artist forum and creative art production network, including a network of end users and their end user contact listing groups, comprising:
(i) computer software including software logic and at least one interface for a network user to be identified by the network as a known prior user, or to provide to the network through the interface enough identifying information to qualify as a newly identified network user, with sufficient permission to access the private or virtual private network,
(ii) computer software including software logic sufficient to verify a network user's identify, and track the network connection of the network user as the network user accesses the private network or virtual private network system, for example by the use of unique network log on identifiers, by a personal registered toolbar, or a combination thereof, and
(iii) computer software implementing a method for (a) accurately identifying and connecting specific network users who are an end user and their invited contacts who wish to access the private or virtual private network after having been referred by the end user, (b) identifying end users who have contact listing referrals as being associated with their referred end users who elect to participate in the creative art production network artistic network forum, (c) identifying product or services advertisers who wish to target said network users with advertisements in exchange payment of advertising revenue to the network when end users access particular artist forum and creative art production network web pages, (d) providing an interface for such product or services advertisers to select artist forum and creative art production network web pages, or sets of web pages and to obtain the right to target such specific network users for a set fee, and (e) providing shared revenue to artist forum and creative art production network web page owners for advertising on their web pages or to visitors of their web pages.

In a further preferred embodiment, the web pages located within the social network are equipped with imbedded information regarding where advertisements can be inserted, or when advertisements can be played . . . such as before the web page is played or simultaneously with the media in a window, banner or background. Tracking software tailors the advertisement to the individual web pages and tracks revenue generated by the web page visitors to whom advertisements are presented.

Without further description, it is believed that one of ordinary skill in the art can, using the preceding description, make and utilize the business method and associated computer systems of the present invention and practice the claimed methods. The examples of encryption and decryption specifically point out preferred embodiments of the present invention, and are not to be construed as limiting in any way the remainder of the disclosure. Such examples are non-limiting in that one of ordinary skill (in view of the above) will readily envision other permutations and variations on the invention without departing from the principal concepts. Such permutations and variations are also within the scope of the present invention.

What is claimed is:

1. A private or virtual private network have computer implemented methods for an artistic creative and communications forum, comprising
a. a computer system running software with software implemented methods providing a secure private or virtual private communications network access for network users identified by the network as having permission for network access as either a member or guest,
b. providing an enhanced way computer assisted production of art and art objects over the centrally managed network,
c. utilizing computer implemented methods for art idea creator network members to communicate with art idea implementers/producers in a forum to produce and sell art or art objects,
wherein art idea creator end users and art idea implementer/producer end users of the private or virtual private network method artistic creative and communications forum receive one or more of prizes, a portion of sale proceeds for any art produced as a direct result of their contributions to the forum, or a portion of advertising proceeds for advertising that targets forum visitors, or viewers of posted art.

2. A private or virtual private network have computer implemented methods for an artistic creative and communications forum according to claim 1, further comprising:
a. a forum for sports fans, hobbyist, or other individual with an artistic idea to post a request for stickers, temporary tattoos, permanent tattoos, art objects, art modified clothing and the like,
b. a forum for artists may offer their ideas in response to an artistic idea posting, or from their own art idea in a closed artist only contest for the idea creator or others to evaluate, or in a public contests for registered users of the forum to evaluate, wherein the winner of an art implementation or art production of a submitted art idea may be rewarded by one or more of a purchase of their idea, a percentage of sales of art or objects that implement the idea, or other compensation, and the person that submitted the artistic idea requesting that their idea be implemented may also be rewarded with a portion of revenue from sales of art or objects, or other revenue.

3. A private or virtual private network have computer implemented methods for an artistic creative and communications forum according to claim 2, wherein the art is selected from two dimensional art, three dimensional art, body art, and multimedia art.

4. A private or virtual private network have computer implemented methods for an artistic creative and communications forum according to claim 2, further comprising periodic contests for the best art idea submission, the best art idea implementation or both, may result in prizes to the winners, and optionally to network member views who vote on the art and best predict the winner of a contest, before the close of a contest.

5. A private or virtual private network have computer implemented methods for an artistic creative and communications forum according to claim 1, comprising
a. a computer system running software with software implemented methods providing a secure private or virtual private communications network access for network users identified by the network as having permission for network access as either a member or guest,
b. software implemented methods for improved computer assisted production of art and art objects comprising a contest forum to evaluate the work of artists in the network forum, while also providing valuable feedback for artists who submit art to the forum to use to improve their art skills and the appeal of their art to others by posting their work in a forum for evaluation by others network members during a periodic art popularity and appeal contest, wherein their art may be compared to the work of other artists in a general artistic sense or compared in regard to their implementation of a contest idea in art form after an art concept idea is submitted to the forum for an art design contest, and
c. providing opportunities and a forum for artists to improve their art skills and appeal of their work to others by resubmitting their art to a forum audience based on improved knowledge of their art's style and skill to appeal to others for evaluation by other network users in order to improve their production of art and art objects.

6. A private or virtual private network have computer implemented methods for an artistic creative and communications forum according to claim 1, comprising
a. a computer system running software with software implemented methods for providing a secure private or virtual private communications network access for network users identified by the network as having permission for network access as either a member or guest, and
b. providing software implemented methods for network managers to track and pay art idea creators and art end users who participate in the forum,
wherein such payment may be shared revenue, free or reduced service costs, gifts or awards, or some combination thereof.

7. A private or virtual private network have computer implemented methods for an artistic creative and communications forum according to claim 6, comprising
a. software implemented methods to identify a network end user in their role as an art idea creator, an art idea implementer/provider, or both, and
b. software implemented methods to establish an end user network member payment account and tracking software for sharing network revenue generated within the network as a result of one or more of:
i. accessing, participating, and contributing by the network end user,
ii. assessing, participation, and winning a prize for accurately choosing and best predicting best art contest winners on the forum,
iii. accessing and providing an art idea or concept that is an art contest winner within the forum, and
iv. accessing and providing an art implementation or art object that is an art contest winner within the forum.

8. A private or virtual private network have computer implemented methods for an artistic creative and communications forum according to claim 1, further comprising an artist social network of private commercial or non-commercial web pages of information and posted art, wherein individual private web page owners can post information, profiles or art for sale, and the forum can optionally agree to pay web page owners a percentage of any revenue from advertising resulting from network use of a frame, or area, of their web page or web pages when the frame or frames is/are used by the network for promoting and offering advertiser's products or services to targeted network users or group of users that visit the private web page, or pages.

9. A private or virtual private network have computer implemented methods for an artistic creative and communications forum according to claim 8, comprising software implemented methods and advertising revenue sharing to promote a method for private artist web page owners in a social artists' network to capitalize on the popularity and appeal value of their private web page, or web pages, and their art, which are located on the social network of private artist web pages.

10. A private or virtual private network have computer implemented methods for an artistic creative and communications forum according to claim 1, comprising software implemented methods and hardware for conducting art auctions or to provide for the sale of art objects in an eStore forum, or the like, wherein the forum may optionally share a percentage of the revenue from such auctions or sales with art idea creators, art idea implementers/producers, or both for any sales of art resulting directly from contributions to the production of saleable art or art objects by art idea creators, art idea implementers/producers, or both, wherein idea creators may be a result of individual or cogeneration creation of art.

11. A private or virtual private network have computer implemented methods for an artistic creative and communications forum according to claim 1, comprising software implemented advertising methods and tracking software providing methods for end users that have a network of contacts that are friends or online acquaintance to invite end users to the forum and to receive revenue, awards or prizes for the number of end users that they invite to the forum and who become forum network member end users after being invited, wherein end users are presented with a way to profit from the network access of the forum and forum participation from their social network of contacts and to capitalize on the popularity and appeal value of their private contacts.

12. A private or virtual private network have computer implemented methods for an artistic creative and communications forum according to claim 1, comprising
(i) computer software including software logic and at least one interface for a network user to be identified by the network as a known prior user, or to provide to the network through the interface enough identifying information to qualify as a newly identified network user, with sufficient permission to access the private or virtual private network,
(ii) computer software including software logic sufficient to verify a network user's identify, and track the network connection of the network user as the network user accesses the private network or virtual private network system, for example by the use of unique network log on identifiers, by a personal registered toolbar, or a combination thereof, and
(iii) computer software implementing a method for (a) accurately identifying and connecting specific network users who wish to access private web pages located within a social network of web pages that are offered on the network, (b) identifying commercial and non-commercial artist web page owners within the artist social network and creative art forum with advertising on their web pages, or associated with their web pages to track their share of advertising revenue generated by visitors to their web pages, (c) identifying product or services advertisers who wish to target said network users with advertisements in exchange for payment of advertising revenue to the network when end users access a particular social network of artist web pages, (d) providing an interface for such product or services advertisers to select network web pages with end users visitors that advertisers wish to target and to obtain the right to target such specific network users for a set fee, and (d) optionally providing shared revenue to commercial and non-commercial artist web page owners within the private network generated by the targeted end users of such web pages.

13. A private or virtual private network have computer implemented methods for an artistic creative and communications forum according to claim 1, including a network of end users and their end user contact listing groups, comprising:
(i) computer software including software logic and at least one interface for a network user to be identified by the network as a known prior user, or to provide to the network through the interface enough identifying information to qualify as a newly identified network user, with sufficient permission to access the private or virtual private network,
(ii) computer software including software logic sufficient to verify a network user's identify, and track the network connection of the network user as the network user accesses the private network or virtual private network system, for example by the use of unique network log on identifiers, by a personal registered toolbar, or a combination thereof, and
(iii) computer software implementing a method for (a) accurately identifying and connecting specific network users who are an end user and their invited contacts who wish to access the private or virtual private network after having been referred by the end user, (b) identifying end users who have contact listing referrals as being associated with their referred end users who elect to participate in the creative art production network artistic network forum, (c) identifying product or services advertisers who wish to target said network users with advertisements in exchange payment of advertising revenue to the network when end users access particular artist forum and creative art production network web pages, (d) providing an interface for such product or services advertisers to select artist forum and creative art production network web pages, or sets of web pages and to obtain the right to target such specific network users for a set fee, and (e) providing shared revenue to artist forum and creative art production network web page owners for advertising on their web pages or to visitors of their web pages.

14. A private or virtual private network have computer implemented methods for an artistic creative and communications forum according to claim 13, further comprising web pages located within the social network are equipped with imbedded information regarding where advertisements can be inserted, or when advertisements can be played, including before the web page is played or simultaneously with the media in a window, banner or background.

15. A private or virtual private network have computer implemented methods for an artistic creative and communications forum according to claim 14, comprising tracking software that tailors the advertisement to the individual web pages and tracks revenue generated by the web page visitors to whom advertisements are presented.
